(19) United States
(12) Patent Application Publication
(10) Pub. No.: US 2008/0147989 A1
(43) Pub. Date: Jun. 19, 2008

(54) Lockdown control of a multi-way set associative cache memory

(75) Inventor: Gerard Richard Williams III, Sunset Valley, TX (US)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/638,709

(22) Filed: Dec. 14, 2006

(51) Int. Cl. G06F 12/16

(52) U.S. Cl. 711/145

(57) ABSTRACT

A multi-way set associative cache memory 6 is provided with lockdown control circuitry 26, 48 for controlling portions of that cache memory to store data which is locked within the cache memory 6 (i.e. not subject to eviction). Programmable lockdown data 38, 40, 42, 44, 46 specifies which ways contain any locked portions and also the size within each way of locked portion. Thus, individual cache ways can be partially locked.

### BACKGROUND OF THE INVENTION

1. Field of the Invention

This invention relates to the field of cache memory. More particularly, this invention relates to the control of lockdown operation within cache memories.

2. Description of the Prior Art

It is known to provide multi-way set associative cache memories. In such memories, a plurality of cache ways are provided, each cache way comprising multiple cache lines and each cache line storing multiple bytes of data taken from corresponding memory addresses. Data from a given memory address may normally be stored in any of the cache ways within a cache line selected in dependence upon a portion (index portion) of the memory address concerned. This is known multi-way set associative cache memory behaviour.

It is also known to provide lockdown mechanisms within such cache memories. These lockdown mechanisms operate by loading particular data (whether that be particular instructions or particular data values) into a cache way and then marking the cache way such that data stored within it is not replaced during the on going use of the cache memory. Other data to be cached will be stored and subsequently evicted within the other cache ways, but the data within the lock cache way will remain stored within the cache and available for rapid access. A typical use of such lockdown mechanisms is to store performance critical instructions within a locked cache way such that when those instructions are needed they are available from the cache. Critical interrupt processing code would be an example instructions which could be locked down within cache way so as to be rapidly available in a predictable amount of time when needed.

### SUMMARY OF THE INVENTION

Viewed from one aspect the present invention provides a multi-way set associative cache memory having lockdown control circuitry responsive to programmable lockdown data to selectively provide a locked portion and an unlocked portion within at least one cache way.

The present technique recognises that in many circumstances it is inefficient to lock down the use of a cache memory at the granuality of a cache way. It maybe that only a portion of a cache way is actually being used to store the data which it is desired to lock down and have permanently available within the cache memory. With way granuality the remaining portion of that cache way is unavailable for use in normal cache operation in a manner in which reduces the effectiveness of the cache memory. The present technique identifies and addresses this problem by providing that at least one cache way can be controlled by lock down circuitry to include a locked portion and an unlocked portion. Accordingly, the data which it is desired to lock down and have permanently available in the cache can be stored within the locked portion of the cache way and the remaining portion of the cache way can be unlocked and be available for use in normal cache operation for the transient storage of data. The provision of cache memory is relatively expensive in terms of circuit area and power overhead and accordingly it is advantageous to make improved use of this provided resource in accordance with the present technique.

It will be appreciated that whilst the present technique would provide some advantage if a cache way was simply split into a fixed size portion which could be selectively locked or unlocked and a portion that remained permanently unlocked, the flexibility and usefulness of the technique is improved when the locked portion and the unlocked portion have respective variable sizes specified by programmable lock down data. In this way, the size of the locked portion can be tuned to the actual size of the data it is wished to store within that locked portion.

Whilst it is possible that the sizes of the locked portion and the unlocked portion can be separately specified within the programmable lockdown data, it is more efficient if one of these sizes is specified by the programmable lockdown data and the other size is derived by being the remainder cache way concerned.

Whilst it will be appreciated from the above that the present technique could be usefully employed in respect of only one of the cache ways, the flexibility and the usefulness of the technique and of the cache memory is improved when each of the cache ways is divisible into a locked portion and an unlocked portion in accordance with the present techniques. In this way, for example, different cache ways can be targeted to store different lockdown portions of data with the individual sizes of the locked portions of each way being tuned to the corresponding size of the data being stored in the that way.

The ability to independently control the sizes of the locked portion in each way is desirable, but it will be appreciated that some advantage would be gained even if the size of the locked portion had to be kept constant across ways providing a locked portion.

Whilst it will be appreciated that the programmable lockdown data can be expressed in a variety of different forms, it is advantageously simple and direct to provide the lockdown data with data specifying whether or not each way has any locked portion and then additionally to specify independently the size of such a locked portion. If no locked portions are provided then the cache can operate as a classic N-way set associative cache.

This size data within the programmable lockdown data could be expressed in terms of the size of the locked portion or the size of the unlocked portion, but is conveniently expressed in terms of the size of the locked portion.

The locked portion can be formed in a variety of different manners, such as a range of cache lines which are to be locked with a top and bottom cache line in that range being specified. Such an implementation would require relatively hardware expensive full comparators to be used. Accordingly, advantageously more straightforward implementations can be provided in which the locked portion is a contiguous set of cache lines starting from a predetermined position (e.g. one end of a cache way) and extending over a number of cache lines specified by set data (i.e. the size of the locked portion for that way). An alternative would be to use a mask type arrangement in which the set data includes values specifying whether predetermined regions are or are not locked (such an arrangement could be used to provide non contiguous locked portions within a cache way if desired for some particular implementation/use). Having provided a lockdown mechanism for specifying locked portions of a cache way, the victims select circuitry is responsive to the locked or unlocked status of individual cache lines within the ways in determining which cache lines are potential cache victims when it is desired to perform a linefill operation. As an example, it maybe that a particular linefill operation corresponds to a collection cache lines which are unlocked in all of the cache ways and so the number of possible cache line victims is equal to the number of cache ways. Alternatively, it could be that some or all of the cache lines which could be possible cache line victims are locked in the cache ways and unavailable for linefill operation. If all of the cache lines were unavailable for a particular cache linefill operation, then it maybe that the data concerned could not be cached as the data which is locked down within the cache memory was deemed more important, although such situations would be likely to be rare and in most cases arranging the cache such that in some cases it was not possible to perform a linefill anywhere within the cache memory would be a disadvantage.

The victim select circuitry in accordance with the present technique is responsive to where a particular cache linefill will occur within a way so as to determine whether or not that particular cache line is or is not locked. In order to facilitate providing this additional capability with a relatively low hardware overhead, preferred techniques reuse at least a portion of an adder circuit that is typically provided for performing add operations associated with program instructions within many of the systems in which the present technique will be used.

In addition to being responsive to the locked or unlocked status of individual cache lines within respective ways, the victim select circuitry can also be responsive to whether those cache lines are or are not storing valid data. It will generally be better to perform a linefill to a cache line within a way when the cache line concerned is not storing valid data rather than to evict valid data from another of the cache ways.

The victim select circuitry can take a wide variety of different forms and will typically implement a victim selection algorithm which can be one of many known algorithms, or a mixture of algorithms, such as a random select algorithm, a round robin algorithm, a least recently used algorithm and an algorithm preferentially selecting cache lines not storing valid data. Other algorithms are also possible.

Viewed from another aspect the present invention provides a method of controlling a multi-way set associative cache memory comprising the step of in response to programmable lockdown data, selectively providing a locked portion and an unlocked portion within at least one cache way.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a data processing system incorporating a cache memory;

FIG. 2 schematically illustrates a multi-way set associative cache memory;

FIG. 3 schematically illustrates a number of programmable registers forming part of lockdown control circuitry;

FIG. 4 is a flow diagram schematically illustrating the determination of whether or not a cache line within a particular way is or is not available for linefill based upon its unlocked or locked status; and

FIG. 5 is a flow diagram schematically illustrating the determination of whether or not a particular way is storing valid data in a cache line which is a candidate for a linefill operation.

### DESCRIPTION OF THE PREFERRED EMBODIMENTS

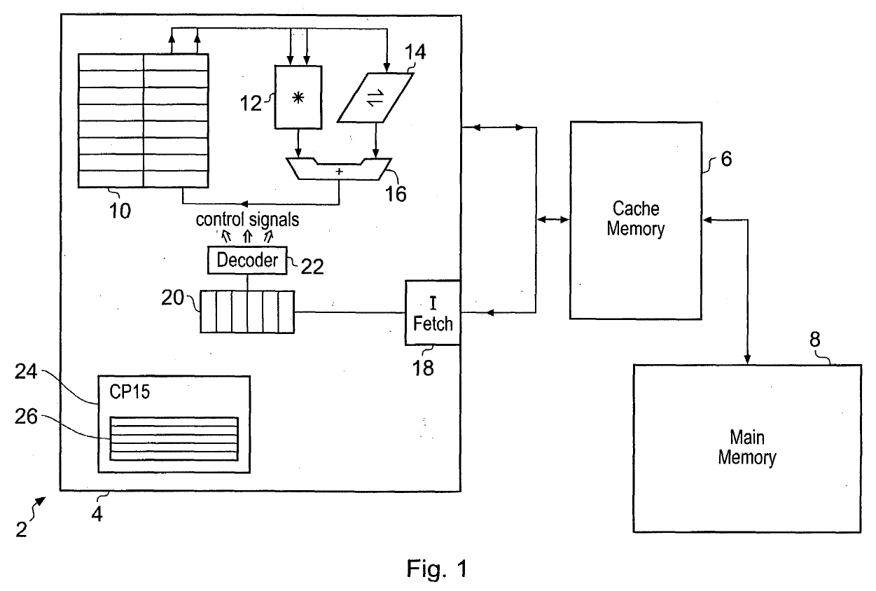

FIG. 1 schematically illustrates a data processing system 2 including a processor core 4, a multi-way set associative cache memory 6 and a main memory 8. The processor core 4 includes a data path comprising a register file 10, a multiplier 12, a shifter 14 and an adder 16. An instruction fetch unit 18 fetches program instructions from the cache memory 6 and the main memory 8 and supplies these to an instruction pipeline 20 from where they are decoded by a decoder 22 to generate control signals for controlling the data path 10, 12, 14, 16 as well as other elements in the processor core 4. It will be appreciated that the processor core 4 will typically include many further circuit elements, but these have been omitted from FIG. 1 for the sake of clarity.

Also included within the processor core 4 is a configuration coprocessor 24 storing a number of configuration registers 26. These configuration registers 26 are used to store programmable lockdown data specifying which cache ways contain any locked portions and the sizes of the locked portions within those cache ways. Thus, the configurations registers 26 form part of lockdown control circuitry in that they feed their signals to victim select circuitry (not illustrated in FIG. 1) which is responsive to the lockdown data to not linefill to cache lines indicated as being within a locked portion of a cache way. In broad terms, the data processing system 2 of FIG. 1 operates to execute program instructions to perform data processing operations upon data values. These program instructions and data values are stored within the cache memory 6 and the main memory 8. Frequently used data values/instructions or data values/instructions which are required for rapid access are stored and/or locked down in the cache memory 6. If a cache miss occurs in respect of a program instruction or a data value, then a fetch is made to the main memory 8 and a linefill operation is performed when the data is passed back to processor core 4 through the cache memory 6 such that the data concerned is then stored within the cache memory 6 for use if accessed again. This type of arrangement is known in this technical field and will not be described further herein.

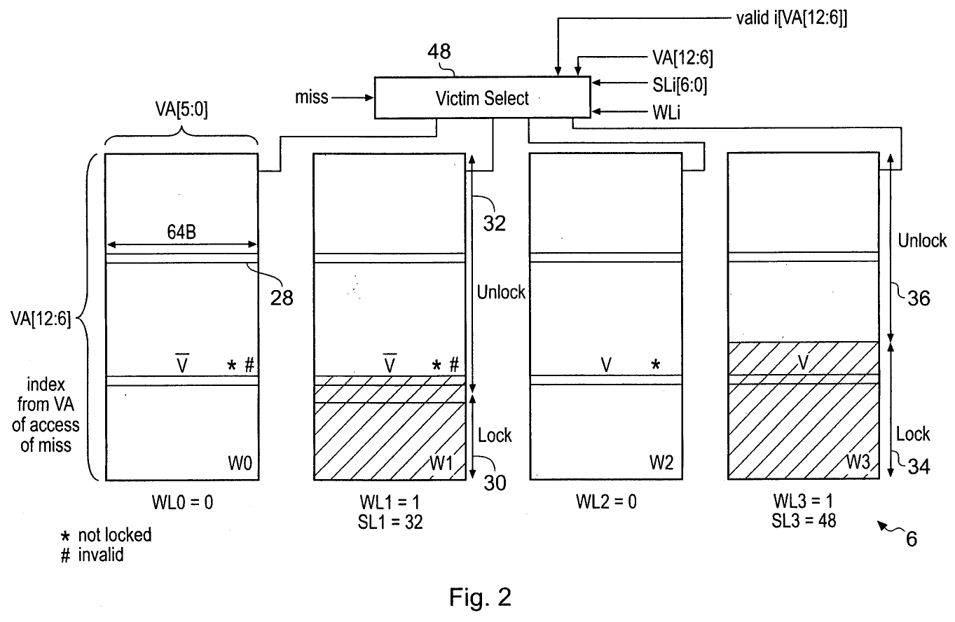

FIG. 2 schematically illustrates the multi-way set associative cache memory 6 in more detail. In this example, the cache memory 6 is a 4-way cache memory with cache ways W0, W1, W2, and W3. In this example, each cache line 28 stores 64 bytes of data. Accordingly, the lower six bits of the virtual address VA [5:0] specify which byte within a cache line 28 is to be accessed. Instructions or data values maybe accessed an manipulated in a word aligned, half word aligned or byte aligned fashion depending upon the particular implementation. It will also be appreciated that the cache line size can vary and 64 bytes is only one example. In this example, seven bits of the virtual address VA[12:6] provide an index value specifying which cache lines are candidates for storing the data values from that virtual address. The higher order virtual address bits form a cache TAG values in the normal way and are stored in a cache TAG portion of the cache memory for not comparson and hit signal generation purposes (not illustrated).

As shown in the particular example of FIG. 2, cache ways W0 and W2 are not subject to any lock down and all of these cache ways are available for storing data upon linefill. By contrast, cache way W1 is subject to lockdown and has a locked portion 30 and an unlocked portion 32. Similarly, the cache way W3 has a locked portion 34 and an unlocked portion 36. In the example shown, the locked portion 30 of cache way W1 is 32 cache lines in size whereas the locked portion 34 of cache way W3 is 48 cache lines in size. The unlocked portion 32 of cache way W1 will be 96 cache lines in size, as this is the remainder of the cache lines in that cache way and the unlocked portion 36 of cache way W3 will be 80 cache lines in size as again this is the unused portion of cache way W3. It will be appreciated that the number of cache lines in a cache way can also vary depending upon the particular design implementation in the same way as the numbers of bytes in a cache line can vary. The locked portions 30 and 34 can be selected to have a size which matches the size of the data (whether that be instructions or data values) to be locked therein. In this example, it will be appreciated that the data to be locked down is arranged within the memory address space so as to be aligned with a way boundary. It is possible that this constraint could be avoided (although it is not difficult to comply with) by specifying the locked portion 30 in terms of a range of cache lines disposed anywhere within the cache way concerned. Such a range could be specified with a start value and an end value or using by a mask value with bits of the mask corresponding to portions of the cache way.

FIG. 2, shows victim select circuitry 48 which serves to implement a victim selection algorithm (which maybe an algorithm of a variety of different forms based upon one or a combination of algorithms, such a random algorithm, a round robin algorithm, a least recently used algorithm, an invalid data preferred data algorithm or another algorithm). In order to select the cache way into which a linefill operation is to be performed when a cache miss occurs and the data is fetched from the main memory 8, the victim select circuitry 48 is provided with a variety of inputs including a miss signal, signals indicating which ways contain any locked portions (WLi) signals indicating the sizes of any locked portions within each way (SLi [6:0]), the index portion of the virtual address of the memory location giving rise to the cache miss (VA[12:6]) and a signal indicating which ways for a given index value contain valid data (validi). Using these inputs, the victim select circuitry 48 selects one of the cache ways into which a cache linefill operation will be performed upon a cache miss. By not selecting ways in which the relevant cache lines are locked, the victim select circuitry 48 preserves the locked nature of those cache lines. Thus, it will be seen in this example implementation that the configuration registers 26 acting in combination with the victim select circuitry 48 serve to provide lockdown control circuitry.

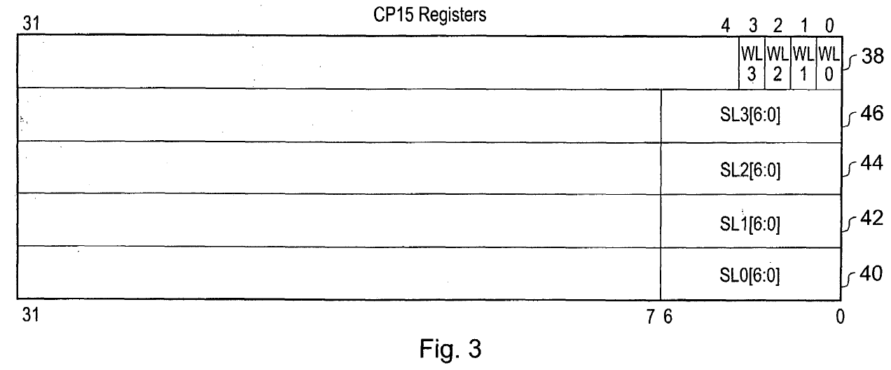

FIGS. 3, 4, and 5 relate to an example embodiment being a cache of 32 KB in size with a 64-byte cache line length.

FIG. 3 schematically illustrates some of the configuration registers 26 of the configuration coprocessor 24 of FIG. 1. In this example, a register 38 includes as its four least significant bits flags indicating whether the four cache ways of the example implementation of FIG. 2 contain any locked portions. If the way locked flags WL0-WL3 are equal to “0” then the cache way concerned does not contain any locked portion whereas if the value is “1” then it does contain a locked portion. Registers 40, 42, 44 and 46 respectively correspond to the different cache ways W0 W3 and include as their least significant seven bits a size specifying value indicating the set data size for the locked portion 30, 34 of the respective ways. The 7-bit value is able to specify a number between 0 and 127 and accordingly specify the size of the locked portion 30, 34 at a granularity of a single cache line. It will be appreciated that the present technique can still be used with advantage with a lower granularity. More generally the size specifying value SLi can be SLi [S−1:0] where S is the number of available sets in a given way, i.e. for a 32 KB cache with 4 ways, the number of sets is given by

S=log2(32768/4(ways)/64(bytes-per-line))=log2(128)=7

and the VA[MB:B] range can be found by the following:

B=log2(bytes-per-line)=log2(64)=6

MB=S−1+B=12

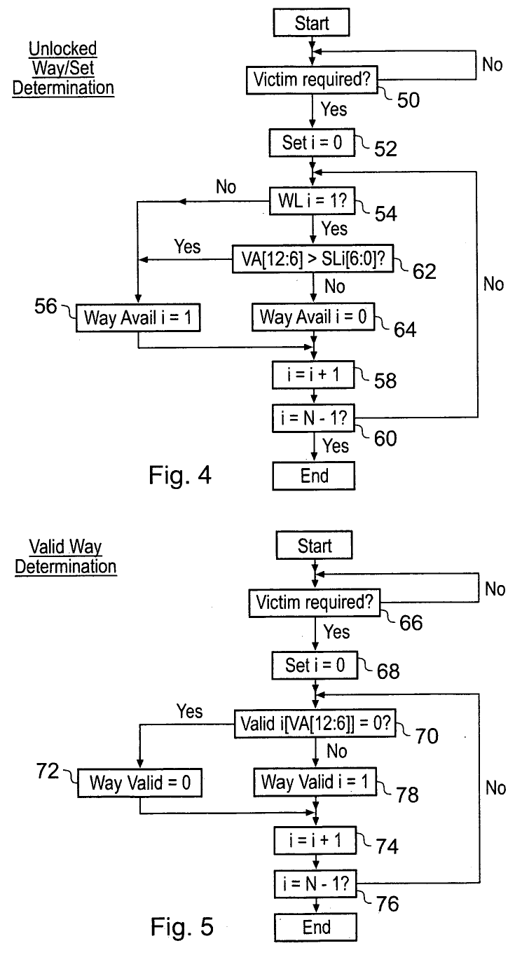

FIG. 4 is a flow diagram illustrating how the victim select circuitry 48 determines for a given virtual address corresponding to a cache miss which ways are available for use in linefill in dependence on their locked or unlocked data. At step 50 processing waits until victim selection is required. At step 5, a way indicator is set to 0 (for an N-way set associative cache memory). At step 54 the way data WLi for the current way is checked to see if it indicates that the way contains any locked portion. If the way data WLi does not equal “1”, then the way concerned does not contain any locked data and processing proceeds to step 56 at which the way concerned is marked as available. Thereafter processing proceeds to step 58 at which point the way indicator is incremented and step 60 where it is tested to see if the last way has been reached. Once the last way has been reached, then the processing is terminated.

If the determination at step 54 was that the way concerned does contain a locked portion (WLi=I is true), then step 62 uses the index portion VA [12:6] of the virtual address concerned (in this example the cache is virtually addressed but it is possible that a physically cache could also be used) to compare against set data SLi for the way concerned to determine whether the index is outside of the locked portion of that way. The adder 16 can be reused (at least partially) to make this comparison. If the index concerned is outside of the locked portion, then processing again proceeds to step 56 where the way is marked as available. If the index is not outside the locked portion, then processing proceeds to step 54 where the way is marked as unavailable and processing proceeds to step 58 as before.

FIG. 5 schematically illustrates how a determination is made for a given index value whether or not the different ways contain valid data for the possible cache lines to be used for pending linefill. At step 66, processing waits until a victim is required for selection. At step 68, the way indicator is set to 0. At step 70, a determination is made as to whether or not the valid flag for the cache line corresponding to the index value of the cache miss is set to a value indicating that the data is invalid. If the data is invalid then processing proceeds to step 72 where the way valid flag for that cache way is set to indicate invalidity. Processing then proceeds to step 74 where the way indicator is incremented and step 76 where a test is made as to whether or not the last way has been reached. If the determination at step 70 was that the way did not contain valid data for the index concerned, then this is marked by step 78 by setting the way valid indicator to indicate that the cache line for that way for the pending index value does contain valid data.

Whilst FIGS. 3, 4 and 5 are for one particular example size/configuration, more generally the cache can be formed of ways WL[N−1] . . . WL[3] WL[2] WL[1] WL[0], where N is the number of cache ways. In this case the size specifying values are given by, SL(n−1)[S−1:0] . . . SL(3)[S−1:0] SL(2)[S−1:0] SL(1)[S−1:0] SL(0)[S−1:0], where S is the number of sets per cache way. In FIG. 4, the step 62 would become VA[S−1+B:B]>SLi[S−1:0] and in FIG. 5 step 70 would become Valid(i)[VA[S−1+B:B]]=0.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. A multi-way set associative cache memory having lockdown control circuitry responsive to programmable lockdown data to selectively provide a locked portion and an unlocked portion within at least one cache way.

2. A multi-way set associative cache memory as claimed in claim 1, wherein said locked portion and said unlocked portion have respective variable sizes specified by said programmable lockdown data.

3. A multi-way set associative cache memory as claimed in claim 2, wherein said programmable lockdown data specifies a size of one of said locked portion and said unlocked portion with said other of said locked portion and said unlocked portion having a size corresponding to a remainder of said at least one cache way.

4. A multi-way set associative cache memory as claimed in claim 1, wherein each cache way of said multi-way set associative cache is divisible into a locked portion and an unlocked portion by said lockdown control circuitry acting in response to said programmable lockdown data.

5. A multi-way set associative cache memory as claimed in claim 1, wherein said lockdown control circuitry and said programmable lockdown data provides for a size of a locked portion and an unlocked portion of each cache way to be independently specified.

6. A multi-way set associative cache memory as claimed in claim 1, wherein said programmable lockdown data includes way data specifying whether or not said at least one cache way has any locked portion.

7. A multi-way set associative cache memory as claimed in claim 1, wherein said programmable lockdown data includes set data specifying a size of at least one of said locked portion and said unlocked portion.

8. A multi-way set associative cache memory as claimed in claim 7, wherein said set data specifies a size of said locked portion.

9. A multi-way set associative cache memory as claimed in claim 1, wherein said programmable lockdown data specifies a size of one of said locked portion and said unlocked portion as a number of adjacent cache lines within said at least one cache way starting from a predetermined cache line.

10. A multi-way set associative cache memory as claimed in claim 1, wherein said programmable lockdown data specifies a size of one of said locked portion and said unlocked portion as mask value with different portions of said mask value specifying whether corresponding portions of said at least one cache way are part of said locked portion or part of said unlocked portion.

11. A multi-way set associative cache memory as claimed in claim 1, comprising victim select circuitry responsive to a cache miss in respective of data stored at a memory address to select a cache line to serve as a cache line victim for a cache linefill operation from among one or more possible victim cache lines within respective cache ways.

12. A multi-way set associative cache memory as claimed in claim 11, wherein said victim select circuitry is responsive to an index portion of said memory address to determine whether a corresponding cache line that would serve as a cache line victim within said at least one cache way in respect of said cache miss is within said locked portion and so is unavailable for said cache linefill operation.

13. A multi-way set associative cache memory as claimed in claim 12, wherein said victim select circuitry when determining from said index portion whether said cache line is within said locked portion reuses at least a portion of an adder circuit used for processing program instructions involving an add operation.

14. A multi-way set associative cache memory as claimed in claim 11, wherein said victim select circuitry is responsive to validity data specifying which of said one or more possible victim cache lines is storing valid data.

15. A multi-way set associative cache memory as claimed in claim 11, wherein said victim select circuitry selects said victim cache line using a victim select algorithm.

16. A multi-way set associative cache memory as claimed in claim 15, wherein said victim select algorithm includes one or more of:
a random select algorithm;
a round robin select algorithm; and
a least recently used select algorithm.

17. A multi-way set associative cache memory as claimed in claim 14, wherein said victim select circuitry selects said victim cache line using a victim select algorithm including an algorithm preferentially selecting cache lines not storing valid data.

18. A method of controlling a multi-way set associative cache memory comprising the step of in response to programmable lockdown data, selectively providing a locked portion and an unlocked portion within at least one cache way.

19. A method as claimed in claim 17, wherein said locked portion and said unlocked portion have respective variable sizes specified by said programmable lockdown data.

20. A method as claimed in claim 19, wherein said programmable lockdown data specifies a size of one of said locked portion and said unlocked portion with said other of said locked portion and said unlocked portion having a size corresponding to a remainder of said at least one cache way.

21. A method as claimed in claim 18, wherein each cache way of said multi-way set associative cache is divisible into a locked portion and an unlocked portion in response to said programmable lockdown data.

22. A method as claimed in claim 18, wherein said programmable lockdown data allows a size of a locked portion and an unlocked portion of each cache way to be independently specified.

23. A method as claimed in claim 18, wherein said programmable lockdown data includes way data specifying whether or not said at least one cache way has any locked portion.

24. A method as claimed in claim 18, wherein said programmable lockdown data includes set data specifying a size of at least one of said locked portion and said unlocked portion.

25. A method as claimed in claim 24, wherein said set data specifies a size of said locked portion.

26. A method as claimed in claim 18, wherein said programmable lockdown data specifies a size of one of said locked portion and said unlocked portion as a number of adjacent cache lines within said at least one cache way starting from a predetermined cache line.

27. A method as claimed in claim 18, wherein said programmable lockdown data specifies a size of one of said locked portion and said unlocked portion as mask value with different portions of said mask value specifying whether corresponding portions of said at least one cache way are part of said locked portion or part of said unlocked portion.

28. A method as claimed in claim 18, comprising in response to a cache miss in respective of data stored at a memory address, selecting a cache line to serve as a cache line victim for a cache linefill operation from among one or more possible victim cache lines within respective cache ways.

29. A method as claimed in claim 28, wherein in response to an index portion of said memory address, determining whether a corresponding cache line that would serve as a cache line victim within said at least one cache way in respect of said cache miss is within said locked portion and so is unavailable for said cache linefill operation.

30. A method as claimed in claim 29, wherein determining from said index portion whether said cache line is within said locked portion, reusing at least a portion of an adder circuit used for processing program instructions involving an add operation.

31. A method as claimed in claim 28, wherein said selecting is responsive to validity data specifying which of said one or more possible victim cache lines is storing valid data.

32. A method as claimed in claim 28, wherein said selecting uses a victim select algorithm.

33. A method as claimed in claim 32, wherein said victim select algorithm includes one or more of:
a random select algorithm;
a round robin select algorithm; and
a least recently used select algorithm.

34. A method as claimed in claim 31, wherein said selecting uses a victim select algorithm including an algorithm preferentially selecting cache lines not storing valid data.
